(19) United States
(12) Patent Application Publication
(10) Pub. No.: US 2024/0286503 A1
(43) Pub. Date: Aug. 29, 2024

(54) ELECTRICAL POWER CABLE CONNECTOR FOR A VEHICLE

(71) Applicant: Robert Bosch GmbH, Stuttgart (DE)

(72) Inventor: Arndt Christian DUERR, Fellbach (DE)

(21) Appl. No.: 18/571,489

(22) PCT Filed: Jun. 13, 2022
(86) PCT No.: PCT/EP2022/065946

§ 371 Date: Feb. 28, 2024

(30) Foreign Application Priority Data
Jun. 25, 2021 (DE) 10 2021 206 603.8

(51) Int. Cl. B60L 53/16; B60L 53/18; B60L 53/60

(52) U.S. Cl. CPC B60L 53/16; B60L 53/18; B60L 53/60; B60L 2250/00

(57) ABSTRACT

A secondary connector of a power cable which is designed for electrical connection to a vehicle. The secondary connector includes a plug-in connector for detachable electrical connection to a power supply device, in particular a cable connection for detachable electrical connection to a coupling of the power cable, a limiting unit which is designed to limit an electric current flowing through the power cable to a maximum value, and an adjusting unit via which the maximum value can be adjusted.

### FIELD

The present invention relates to a connector of a power cable for electrically connecting a vehicle, in particular an energy store of a vehicle, wherein the connection can be established in particular to a power supply device. The connector serves to electrically couple the power cable to the power supply device. Such a connector can be referred to as a secondary connector, while the primary connector is the connector that connects the power cable to the vehicle. The primary and secondary connectors can also be referred to as charging plugs. The present invention also relates to a power cable comprising such a connector. The power cable can, for example, be a charging cable, which is designed to transfer powers of at least 0.5 kW, preferably of at least 2 kW electrical power.

### BACKGROUND INFORMATION

Various approaches are described in the related art for electrically charging electric vehicles or hybrid vehicles (e.g., cars, trucks, boats, aircraft, two-wheelers, etc.). In particular, the following case groups can be distinguished: charging of the vehicle can take place in a first charging situation via a dedicated charging infrastructure, wherein the charging stations are in particular fixedly installed charging stations. For example, such charging stations are realized as a charging column or wall box. In an alternative charging situation, a continuous current socket is provided, as is used, for example, in normal households for energy supply. For example, this is a 220 V Schuko socket or a socket designed according to other regional standards or customs, wherein a three-phase current connection can also be provided. In this case, a connecting line of the charging cable generally has an integrated controller, which is also referred to as an in-cable control box, ICCB, and which is arranged between the two connectors within the connecting line. This integrated controller serves to communicate with the vehicle and to release and adjust a charging current since, in contrast to a charging column or a wall box, a Schuko socket generally does not have a communication line via which the vehicle can communicate with the power supply device.

If a household socket is used for charging the electric vehicle or the hybrid vehicle, a charging current will usually be limited to a maximum value that is below a maximum value at which the household socket is usually fused. In a 16 A fusing, which is, for example, customary in Germany, the integrated controller of the charging cable is generally adjusted in such a way that a maximum current consumption of 13 A is made possible.

A secondary connector and charging cable are described in German Patent Application No. DE 10 2021 203 362 A1.

### SUMMARY

A secondary connector according to the present invention permits a connection between a power cable and a power supply device. In addition, the secondary connector makes possible an adjustable and thus flexible current limitation. Thus, on the one hand, the power supply device can be protected from overloading and, on the other hand, the current limitation function for the power cable is only present when desired, i.e., if the secondary connector is also present. For example, the secondary connector according to the present invention can be designed for a household socket for which a current limitation function is provided. Moreover, for example by recoupling the secondary connector, a further secondary connector for connecting to a (different) charging infrastructure assigned thereto, e.g., a type 2 plug at which a current limitation cannot be adjusted, can, for example, be used on the power cable. Inadvertently retaining the current limitation for the power cable when the secondary connector is changed is thus prevented. It should be noted that the present invention is not limited to secondary connectors for household sockets and in particular also includes other secondary connectors, such as type 2 plugs, with a current limitation function.

The secondary connector can in particular be used as part of a power cable for electrically connecting a vehicle, in particular an energy store of a vehicle, to a power supply device providing electrical energy. The secondary connector in particular serves to electrically connect to a continuous current socket or household socket or to a usual continuous three-phase socket. The vehicle and the power supply device are different units or components. The secondary connector has a plug-in connector, which is provided for detachable electrical connection to the power supply device. For example, the plug-in connector is a Schuko plug. The plug-in connector can also be designed to connect to a dedicated or an assigned charging infrastructure, e.g., a wall box or charging column. It can, for example, be a type 2 plug. In particular, the secondary connector has a cable connection for detachable electrical connection to a coupling of the power cable.

According to an example embodiment of the present invention, the secondary connector furthermore has a limiting unit. The limiting unit serves to limit an electrical current flowing through the secondary connector and/or through the power cable to a maximum value. It is designed for limiting or is configured for this purpose. The limiting unit is thus in particular provided in order to specify a maximum value for the current flowing through the secondary connector and/or through the power cable, as protection of the power supply device against overloading. Limiting the flowing current to the maximum value can take place actively, for example by a circuit of the limiting unit that does not allow the flowing current to increase above a maximum value. Limiting the flowing current to the maximum value can alternatively or additionally take place (indirectly or passively) by transferring the maximum value to the vehicle and/or to a charging controller of the power cable and/or to a charging control logic of the power supply device, so that no current that exceeds the maximum value is requested by the vehicle or supplied by the power supply device.

According to an example embodiment of the present invention, the secondary connector advantageously has an adjusting unit. The maximum value can be adjusted via the adjusting unit, in particular by a user.

The secondary connector thus allows the (flexible) adjustment of the maximum value of the flowing current as well as a limitation of the flowing current to the maximum value. By in particular forming the adjusting unit in the secondary connector, it is on the one hand achieved that, when connecting the secondary connector, a user is reminded by looking at the adjusting unit to adjust the maximum value if necessary. For a user, the adjustment of the maximum value is thus linked directly to the process of electrically connecting the secondary connector and the power supply device. This reduces the risk of the adjustment of the maximum value being forgotten. On the other hand, it is ensured that the limitation to the maximum value takes place only if the secondary connector is used. Thus, different secondary connectors can, for example, be attachable to supply cables. If the adjusting unit and the limiting unit are attached to the secondary connector, the adjustment and limiting units will then not be present when the secondary connector is replaced, as described above, by a different secondary connector (without such an adjusting and limiting unit) on the power cable. Inadvertently retaining a current limitation, e.g., one selected to be very low, for different charging situations is thus prevented.

The effect of the flexible adjustment of the maximum value advantageously is that, for example, the tripping of a fuse is prevented, or an overloading of the current branch at which the secondary connector is connected. This can be the case, for example, if a plurality of vehicles are to be charged simultaneously at a household socket or at an individually fused current branch, e.g., in a garage. In this case, if each power cable is adjusted in a fixed manner to a maximum value of 13 A, for example, and the current branch is designed or fused at a maximum of 16 A, the fuse may be tripped during simultaneous charging. This impairs charging comfort for the user. Also possible are situations in which only one vehicle is charged, but other electrical consumers are also simultaneously operated, at least temporarily, in parallel with the charging process at the current branch fused at, for example, 16 A. These consumers can, for example, be household appliances, such as a refrigerator, or tools, such as a drill, or gardening tools, such as a hedge trimmer or a lawnmower. In all these cases, it is advantageous if the user of the charging cable with knowledge of the on-site situation can flexibly limit the maximum value of the charging current by means of the adjusting unit. This flexible adjustment option is particularly advantageous if the secondary connector remains at the selected location and, at a different location, the connecting line of the power cable is connected to a different secondary connector with, in its turn, a different, flexibly adjusted maximum value. In this way, the maximum value of the flowing current can be adjusted in a particularly user-friendly manner on the basis of the local situation (performance capability of the current branch) and/or of time-related circumstances (parallel operation of a plurality of consumers), and a sudden interruption of the charging process as a result of the fuse being tripped or the current branch being overloaded can be prevented.

Preferred developments of the present invention are disclosed herein.

According to an example embodiment of the present invention, the adjusting unit preferably has a rotary knob or a slider or a touchscreen or a keypad for inputting the maximum value. In this way, the user themselves can specify the maximum value.

The design as a rotary knob or as a slider advantageously permits a particularly simple and inexpensive production of the adjustment apparatus. It is haptically effectively and intuitively operable for a user. The design as a touchscreen advantageously enables use for different adjustment processes and can be designed particularly simply to be watertight, which is particularly advantageous for charging processes in humid environments. The embodiment as a keypad advantageously permits a particularly intuitive and precise adjustment of the maximum value.

In a further embodiment of the present invention, it is provided that the power cable has a display on which the limit value is displayed as a suggestion in order to aid the user in adjusting the maximum value via the adjusting unit.

In a development of the present invention, the maximum value can advantageously be selected from a plurality of predefined values via the adjusting unit. The predefined values are, in particular, fixedly adjusted current values, such as 2 A, 4 A, 6 A, 8 A, 10 A and 13 A. If the adjusting unit is, for example, designed with a rotary knob or slider as described above, the rotary knob and/or the slider can preferably have latching steps that correspond to the corresponding predefined values. When using a touchscreen, individual buttons that correspond to the steps can be displayed and, when using a keypad, individual keys can, for example, be assigned to fixed maximum values. Simple and intuitive adjustability of the maximum value is thus given. Alternatively or additionally, the maximum value can be steplessly adjusted from a predefined interval via the adjusting unit. The predefined interval is, for example, the interval between 1 A and 13 A. The term “stepless” in this context in particular means that a smallest gradation that is unavoidable in digital signal processing is at most 0.2 A or at most 0.1 A.

According to an example embodiment of the present invention, the secondary connector advantageously has a memory. The memory serves for storing different maximum values, in particular by the user. It can be designed to store different maximum values. Thus, if the adjusting unit does not have a rotary knob or a slider as described above, predefined values can, for example, be stored, which can in particular be adjusted simply and intuitively as the maximum value for the limiting unit. Thus, different maximum values for different power supply devices that are used more frequently can in particular be stored and simply and cost-effectively be retrieved in order to achieve rapid configuration of the secondary connector. If, for example, as described above, a reasonable limitation of the current is 8 A in a first garage and 12 A in a second garage, the two maximum values can be stored in the memory and can be retrieved and/or adjusted quickly and simply depending on the location of the charging process.

According to an example embodiment of the present invention, the secondary connector preferably has a communication module. The communication module in particular serves for communication with a user terminal. It is thus provided that the maximum value can be set or adjusted via the user terminal. The communication module can, for example, be configured for wireless communication with the user terminal.

According to an example embodiment of the present invention, the user terminal is, for example, a smartphone. A user of the user terminal can thus advantageously configure the secondary connector or adjust the maximum value in a particularly simple manner and also from a greater distance. In addition, it can, for example, be provided that the communication module is designed to send to the user terminal signals that contain a current currently flowing through the secondary connector and/or an electrical energy that has flowed through the secondary connector Statistics and/or billing functions for the charging process can thus, in particular, be simply and cost-effectively realized or retrieved for the user or a provider of energy.

According to an example embodiment of the present invention, the secondary connector preferably has a release unit, which is designed to release the adjustability of the maximum value via the adjusting unit. The release unit can, for example, have a locking slider and/or a mechanical or electronic lock and/or a fingerprint sensor. The release unit prevents an unintentional or undesired manipulation or adjustment of the maximum value from taking place, for example. This could, for example, happen by accidentally displacing a slider or a rotary knob. By means of a mechanical lock, the mechanical adjustability of the adjusting unit can, for example, be prevented. By means of an electronic lock, the adjustment or changing of the maximum value can in particular be prevented, even though mechanical access to the adjusting unit is still allowed. The mechanical lock can, for example, be a locking of the rotary slider or of the rotary knob as described above. The electronic lock is advantageously a software solution which prevents newly adjusted maximum values from being accepted as long as this input has not been released. The use of a fingerprint sensor particularly advantageously makes it possible to prevent the setting or adjustment of the maximum value unless an authorized person that is unambiguously authenticated by the fingerprint sensor performs this adjustment. This advantageously increases the safety of use of the secondary connector.

In an advantageous development of the present invention, it is provided that the secondary connector has a reset function, wherein a maximally possible maximum value is adjusted or input when the reset function is activated. The maximally possible maximum value can, for example, be a technically maximally possible maximum value, i.e., a maximum value that is specified by technical limitations. For example, it may be provided that the reset function can be activated by a user and/or is activated, in particular automatically activated, for example by mechanical and/or electrical/electronic means, when the supply cable is decoupled from the power supply device. The reset function makes it possible for a maximally possible maximum value, for example a technically maximally possible maximum value, to be adjusted or input. As described above, the (for example technically) maximally possible maximum value can in particular be a value that corresponds to the current-carrying capacity of the secondary connector and/or of the power cable. In other words, a user can reset adjusted lower maximum values via the reset function and can thus allow a physically maximally possible current through the secondary connector and/or through the power cable. As a result, a very rapid setting or adjustment can advantageously be performed, which increases user-friendliness.

According to an example embodiment of the present invention, the limiting unit is advantageously designed to output or send the maximum value to the vehicle and/or to a charging control logic of the power cable or of the power supply device. In particular, the limiting unit is designed to notify the vehicle that the maximum value output or sent or transferred can at most be requested as the charging current. The current flowing through the power cable can thus be simply and reliably limited by the limiting unit. For this purpose, the limiting unit merely communicates the maximum value to the vehicle and/or the charging control logic, as a result of which the vehicle and charging control logic start a charging process during which the maximum value is not exceeded. Transferring the maximum value to the vehicle and/or the charging control logic can, for example, take place via a communication line provided for communication between the vehicle and the charging control logic.

Alternatively or additionally, according to an example embodiment of the present invention, the maximum value can be transferred in such a way that the power cable has a variable current-carrying capacity coding that can be read by the vehicle and/or the charging control logic. This current-carrying capacity coding can in particular be used to limit the charging current flowing through the power cable. Alternatively or additionally, the maximum value can also be transmitted or output or sent wirelessly.

In this way, it is advantageously brought about that the limiting unit can be designed to be particularly compact, since an electrical or electronic (active) current limitation or a circuit configured for this purpose need not necessarily be provided. As a result, the secondary connector can be constructed to be simpler, more cost-effective and more space-saving or more compact and more lightweight.

According to an example embodiment of the present invention, the secondary connector preferably has a detection unit, which is configured to monitor the electrical current supplied by the power supply device. In addition, the detection unit is in particular designed to detect an interruption of the supplied electrical current. If such an interruption is recognized, in particular unexpectedly and/or abruptly, i.e., not at the end of a charging process, this can generally be attributed to the tripping of a fuse of the power supply device. The secondary connector can thus recognize if the current previously flowed was too high and brought about an overloading of the power supply device. The detection unit is advantageously designed to detect the interruption if the supplied electrical current is reduced by more than 90% within a time interval of, for example, less than 1 s. Advantageously, the interruption is detected by the detection unit if the supplied electrical current is reduced by more than 90% within a time interval of less than 100 ms. As a result of such an abrupt drop in the electrical current, it can be concluded that the fuse of the power supply device has tripped. The current flowing through the supply cable can, in particular, also decrease when a charging process is terminated, for example by the vehicle. In this case, however, there will be no correspondingly abrupt drop in the electrical current, so that detection of the interruption can take place reliably on the basis of the criteria described above. Or a signal that the current has reduced or been interrupted can be transmitted to the secondary connector from the vehicle or an ICCB or a charging control logic of the power supply device. In this case, by comparing the current to be expected with the current ascertained during monitoring, it can be determined whether there is a conspicuous difference, for example, in a comparison between the target value and the actual value. If there is such a conspicuous difference in the comparison, this can be understood as an unexpected interruption which, for example, indicates a tripping of the fuse.

Due to the detection unit, it can advantageously be reliably recognized that overloading has occurred, and this can be used for a subsequent charging process or for informing the user.

According to an example embodiment of the present invention, the detection unit is advantageously designed to adjust the limit value as the maximum value or to suggest it to a user as an input for the maximum value.

According to an example embodiment of the present invention, the secondary connector advantageously has an output unit. The output unit is in particular configured to output a signal, in particular an acoustic or visual warning, when the detection unit detects the interruption.

As a result, the user can advantageously recognize that the adjusted maximum value was possibly too high and can respond thereto by a reduction in the maximum value in order to thus prevent repeated interruption of the charging process and/or permanent overloading of the current branch.

According to an example embodiment of the present invention, alternatively or additionally, the output unit is designed to output a signal that the maximum value adjusted by the limiting unit is lower than a maximally possible maximum value. The maximally possible maximum value is, in particular, a technically maximally possible current that can flow through the secondary connector and/or the power cable without damaging it or violating any other specifications of the secondary connector and/or power cable.

The user can thereby advantageously recognize that a charging process can take longer than would be possible in the best case utilizing the maximally possible maximum value. In this way, it can advantageously be prevented that, after the user has previously charged at a low maximum value at a location, the user retains this low maximum value by mistake, even though a significantly higher current consumption would be possible at the next charging location.

The signal output by the output unit can, in particular, also be transferred to a user terminal, such as in particular a smartphone, in order to indicate corresponding warnings and/or information to the user of the power cable on the user terminal.

Furthermore, according to an example embodiment of the present invention, it is preferably provided that the detection unit is configured to transfer or send a limit value, based on a current supplied prior to the detection of the interruption, as the maximum value to the limiting unit and/or to output it as a proposal for input as the maximum value. The detection unit is in particular designed to additionally take into account a safety margin for the (new) maximum value or limit value. The safety margin is in particular at least 5% of the ascertained limit value (i.e., of the current that flowed prior to the interruption), preferably at least 10% (e.g., if 10 A is ascertained as an interruption current value, the new limit value will be 9.5 A with a 5% safety margin, 9.0 A with a 10% safety margin). Alternatively or additionally, said safety margin is advantageously at least 0.5 A, particularly advantageously at least 1.0 A, for example exactly 0.5 A or exactly 1 A. It is preferably provided that the detection unit is designed to ascertain the limit value on the basis of the last current value detected prior to the interruption. Alternatively, it is provided that the detection unit is designed to ascertain the limit value on the basis of the mean value of a plurality of detected current values in a predefined time window prior to the interruption (e.g., within the last 100 ms prior to the interruption). As a further alternative, it is provided that the detection unit is designed to ascertain the limit value by applying a filtering to a plurality of detected current values prior to the interruption. Alternatively, the limit value can also be ascertained by forming a time derivative of the current and assuming the interruption event when a limit value of the derivative is exceeded. One or more of the current values prior to the limit value can then be used for determining the (new) maximum value or the limit value.

Alternatively or additionally, according to an example embodiment of the present invention, it may be provided to ascertain the interruption by the following steps: (a) reading or ascertaining a target value for the current, (b) reading or ascertaining an actual value for the current, (c) comparing the target value and the actual value, for example by a difference formation or the like, (d) deciding on the basis of the comparison whether an interruption is present, for example if a difference value of the target value and the actual value exceeds a threshold value.

All these alternatives can advantageously also be combined. If the limit value is ascertained as described above on the basis of the last current value detected prior to the interruption, it is in particular provided that the detection unit ascertains the interruption as an event during which the flowing current drops. The measured values of the flowing current that were ascertained prior to said drop in the current are in particular values that can be accepted as the limit value, advantageously with said safety margin. The last current value detected prior to the interruption is thus in particular a current value from which a drop in the current was ascertained. If the detection apparatus determines, for example, that a current current value is considerably lower than a previously ascertained current value, an interruption is present and the previously ascertained current value is the last current value detected prior to the interruption. If a mean value of a plurality of detected current values prior to the interruption is used to ascertain the limit value, the mean value can be a weighted or unweighted mean value. In particular, measured current values that are closer in time to the interruption can in particular be weighted higher than measured current values that have a greater time distance from the interruption. The predefined time window prior to the interruption is in particular designed in such a way that it has a duration of at most 2 s. Alternatively, the time window has a duration of at most 1 s. It is also advantageously provided that the time window lasts at most 500 ms, in particular 200 ms. If the current value is ascertained at a sampling time of 50 ms, at least 4 current values are in particular taken into account in ascertaining the mean value, alternatively 10 measurement values or 20 measurement values or 40 measurement values. The above-described safety margin makes it possible for the limit value to be below the tripping threshold of the fuse, even when taking into account tripping tolerances of a fuse of the power supply device. When the limit value ascertained in this way is used, the risk of re-tripping the fuse of the power supply device is thus minimized since the current flowing through the power cable remains below a value that has already previously not led to a tripping of said fuse of the power supply device. The limit value ascertained by the detection unit is thus a value of the current that remains below a current triggering the interruption, since the limit value is based on a current supplied prior to the interruption. This limit value can either be transferred directly to the limiting unit so that the latter adopts the limit value as the maximum value. Alternatively or additionally, said limit value can also be output or sent or transmitted, for example to a user or to a display or to a user terminal, as a result of which the limit value serves as a proposal for input or adjustment as the maximum value, for example by a user. The maximum value adjusted in this way thus makes it possible to reduce a risk of a further tripping of the fuse of the power supply device since the maximum current flowing through the power cable is limited to a value at which no tripping of the fuse previously took place. On the other hand, this makes it possible to allow the greatest possible current to flow through the power cable, since the maximum value is ascertained on the basis of the limit value and thus does not have to be estimated, possibly incorrectly, by a user. As a result, even after the fuse has been tripped, it is advantageously simultaneously possible to maintain the safety of the current branch and to minimize the charging duration.

The present invention furthermore relates to a power cable. According to an example embodiment of the present invention, the power cable for electrically connecting an energy store of a vehicle to a power supply device providing electrical energy has a connecting line or power line and a primary connector, which is or can be electrically coupled to the connecting line. The primary connector has a vehicle connection designed for detachable electrical connection to the vehicle, in particular to the energy store of the vehicle. The primary connector is, for example, a type 2 plug or another plug type designed for connecting to the vehicle. Furthermore, the power cable has a secondary connector, which is or can be electrically coupled to the connecting line and is provided for detachable electrical connection to the power supply device. The secondary connector is in particular detachably connected to the connecting line or power line; alternatively, it can also be connected to the connecting line or power line in a non-detachable or destructively detachable manner. The secondary connector preferably has a limiting unit. The limiting unit serves or is designed for limiting an electrical current flowing through the secondary connector and/or through the power cable to a maximum value. The limiting unit is thus in particular provided in order to specify a maximum value for the current flowing through the secondary connector and/or through the power cable, as protection of the power supply device against overloading. The specification of the maximum value of the flowing current can take place either actively, for example by a circuit of the limiting unit, or (indirectly or passively) by transfer of the maximum value to the vehicle and/or a charging controller of the power cable and/or to a charging controller of the power supply device. In addition, the secondary connector advantageously has an adjusting unit. The maximum value can be adjusted via the adjusting unit, in particular by a user. The secondary connector thus in particular allows the adjustment of the maximum value of the flowing current as well as a limitation of the flowing current to the maximum value. By in particular forming the adjusting unit in the secondary connector, it is on the one hand achieved that, when connecting the secondary connector, a user is reminded by looking at the adjusting unit to adjust the maximum value if necessary. For a user, the adjustment of the maximum value is thus linked directly to the process of electrically connecting the secondary connector and the power supply device. This reduces the risk of the adjustment of the maximum value being forgotten. On the other hand, it is ensured that the limitation to the maximum value takes place only if the secondary connector is used with this limiting unit and the adjusting unit. Thus, different secondary connectors can, for example, be attachable to power cables. If the adjusting unit and the limiting unit are attached to the secondary connector, they may, for example, not be present when the secondary connector is replaced, as described above, by a different secondary connector on the power cable. Inadvertently retaining a (lower) current limitation for different charging situations is thus prevented.

According to an example embodiment of the present invention, the connecting line or the power line of the supply cable advantageously has a coupling. The coupling is designed to be detachably electrically connected to the secondary connector. Thus, different secondary connectors can in particular be attached to the power cable. The power cable can thus be designed, for example, to also accommodate, in addition to the above-described secondary connector, secondary connectors that enable an electrical connection to other types of power supply devices.

In a preferred embodiment of the present invention, it is also provided that the secondary connector and/or the power cable can be switched between a learning mode and a normal mode. The limiting unit is designed in learning mode to gradually increase the current flowing through the secondary connector and/or the power cable, according to a predefined rule up to the adjusted maximum value. In normal mode, the limiting unit is designed to limit the current flowing through the secondary connector and/or the power cable to the maximum value. A difference between the learning mode and the normal mode is in particular such that the limiting unit in learning mode does not directly enable a current up to the maximum value but delays an increase in the current. In this way, a possible interruption of the current prior to reaching the adjusted maximum value can in particular be reliably recognized. It can thus be recognized in an improved manner whether an interruption takes place and at which current value the interruption takes place. The limit value can thus be ascertained more accurately. The detection unit is alternatively or additionally designed to carry out monitoring of the electrical current supplied by the power supply device, at a higher monitoring rate in learning mode than in normal mode. This additionally enables improved and more accurate ascertainment of the interruption of the current in order to be able to thus ascertain the limit value more accurately. If, for example, it is provided that a current value is ascertained or read from a sensor every 50 ms in normal mode, it is, for example provided in learning mode that a measurement value is ascertained or read from said current sensor every 10 ms or every millisecond. The limit value can thus be ascertained safely and reliably as a result of the learning mode. If, in learning mode, an interruption of the current takes place during the increase of the current up to the maximum value, the probability of a further interruption when the power cable is again used at the power supply device is minimized since the limiting unit and the detection unit have reached the boundary conditions for the greatest possible accuracy in ascertaining the limit value. If no interruption takes place during the learning mode, the flowing current can at most assume the maximum value, as a result of which no further influences on the charging process are performed with the exception of the delay of the increase in the current up to the maximum value. The learning mode is, in particular, advantageous in a first use of the power cable at an unknown power supply device in order to test a fuse of the power supply device. Particularly advantageously, the learning mode can be applied several times in succession if an interruption was detected in learning mode. In this case, the previously ascertained limit value can be used as the maximum value for a new run of the learning mode. If, for example, the first maximum value is 13 A and an interruption takes place at 10 A, the maximum value can be adjusted to 10 A or to 10 A minus a safety margin, e.g., to 9 A or 9.5 A, for the next learning process. A tripping threshold of a fuse of the power supply device can thus be ascertained accurately and reliably.

According to an example embodiment of the present invention, the predefined rule is advantageously a predefined ramp for increasing the current. The predefined ramp starts from a predefined starting value, which can, for example, be 0 A or 1 A or 2 A. Starting from this predefined starting value, the ramp allows an increase in the current by means of a predefined gradient, e.g., 1 A/s or 0.5 A/s or 0.1 A/s. The predefined ramp can, in particular, also be designed in multiple steps and comprise different gradients, e.g., a first range with a first gradient and a second range with a second gradient, wherein the second gradient enables a flatter increase in the current (e.g.: first gradient: 1 A/s to 2 A or to 4 A below the maximum value, second gradient: 0.1 A/s up to the maximum value). The current flowing through the power cable is thus first increased with the first gradient, subsequently with the second gradient until the maximum value is reached. Since a risk of an interruption of the current increases with increasing current intensity, better monitoring in the range of said maximum value is thus made possible. The predefined ramp can, in particular, also be designed in such a way that it starts from a predefined starting point selected on the basis of the maximum value. Thus, said ramp can, for example, comprise a range of 80% below the maximum value up to the maximum value or 50% below the maximum value up to the maximum value. In any case, the ramp achieves that an increase in the current cannot take place abruptly, which would make detection of the limit value more difficult. By using the ramp, the limit value can rather be ascertained simply and reliably, in particular also accurately.

### BRIEF DESCRIPTION OF THE DRAWINGS

Exemplary embodiments of the present invention are described in detail below with reference to the figures.

FIG. 1 is a schematic representation of a power cable according to an exemplary embodiment of the present invention in its intended use.

FIG. 2 is a schematic detailed view of a secondary connector of the power cable according to the exemplary embodiment of the present invention.

FIG. 3A shows a current flow during a first operating mode of the power cable according to the exemplary embodiment of the present invention.

FIG. 3B shows a current flow during a second operating mode of the power cable according to the exemplary embodiment of the present invention.

FIG. 4A is a first schematic detailed view of the secondary connector of the power cable according to the exemplary embodiment of the present invention.

FIG. 4B is a second schematic detailed view of the secondary connector of the power cable according to the exemplary embodiment of the present invention.

FIG. 5 is a further schematic detailed view of the secondary connector of the power cable according to the exemplary embodiment of the present invention.

### DETAILED DESCRIPTION OF EXAMPLE EMBODIMENTS

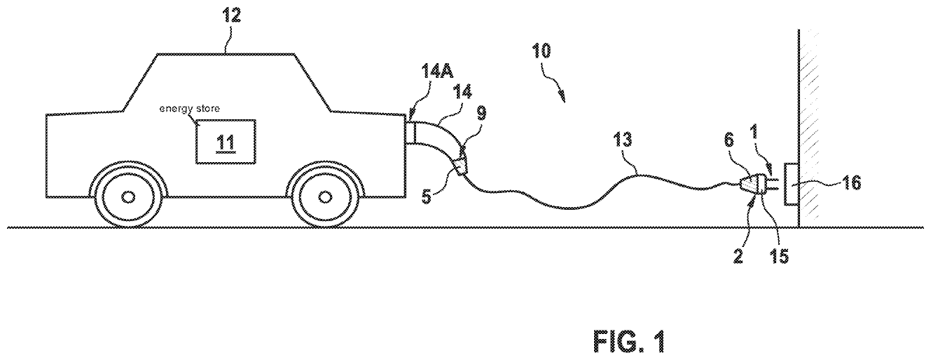

FIG. 1 schematically shows a vehicle 12 with an energy store 11 and a power supply device 16. In this case, merely by way of example, the power supply device 16 is designed as a household socket, e.g., as a Schuko socket. In principle, however, it can also be a type 2 socket of a wall box or of a charging column or a three-phase current connection, without being limited to one of these types. In addition, FIG. 1 shows the intended use of a power cable 10 according to an exemplary embodiment of the present invention.

The power cable 10 has a connecting line 13 or power line 13, which is electrically coupled at one end to a primary connector 14 and at another end to a secondary connector 15. The electrical coupling between the connecting line 13 or power line 13 as well as the primary connector 14 and the secondary connector 15 can be permanently present, while an alternative embodiment is shown in FIG. 1. It is provided here that the coupling of the primary connector 14 and of the secondary connector 15 to the connecting line 13 takes place in each case via a detachable connection. For this purpose, the connecting line 13 has a coupling 6 and an additional coupling 5, wherein the coupling 6 serves to electrically connect to the secondary connector 15. The additional coupling 5 serves to electrically connect to the primary connector 14. For this purpose, the secondary connector 15 has a cable connection 2, which is designed for electrically connecting to the coupling 6 of the connecting line 13. The primary connector 14 has an additional cable connection 9, which is designed for electrically connecting to the additional coupling 5 of the connecting line 13. In principle, it can also be provided that only the primary connector 14 or only the secondary connector 15 is detachably coupled to the connecting line 13 and the respectively other connector is fixedly coupled or connected to the connecting line.

The primary connector 14 also has a vehicle connection 14A, via which an electrical connection to the vehicle 12, in particular to the energy store 11, can be established. The secondary connector 15 has a plug-in connector 1, which is designed for detachable electrical connection to the power supply device 16. The vehicle 12, in particular the energy store 11, and the power supply device 16 can thus be electrically connected to one another via the power cable 10.

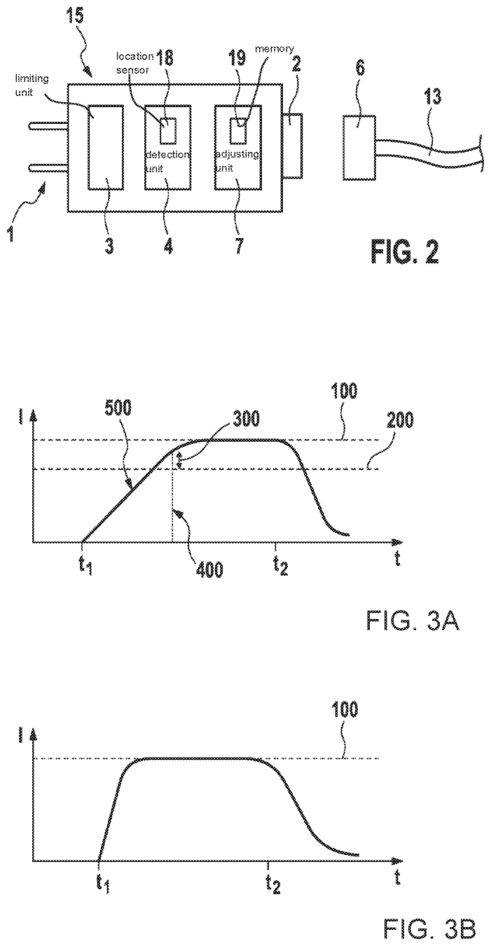

The secondary connector 15 allows or enables a current limitation function in order to, for example, recognize and/or prevent an overloading of the power supply device 16. As shown in FIG. 2, it is advantageously provided that the secondary connector 15 has a limiting unit 3, which is designed for limiting a current flowing through the power cable 10. Advantageously, a detection unit 4 and/or an adjusting unit 7 are additionally provided. The detection unit 4 is advantageously configured to monitor the electrical current supplied by the power supply device 16. In addition, the detection unit 4 is preferably configured to detect an interruption of the supplied electrical current. Details of the detection unit 4 are described below with reference to FIG. 3A and FIG. 3B.

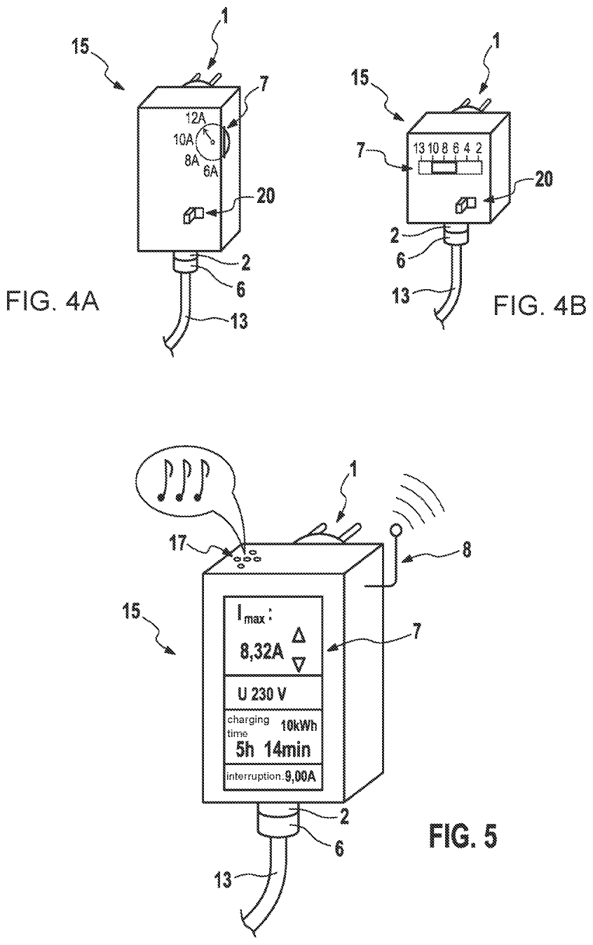

The adjusting unit 7 allows the adjustment of a maximum value 100, which is taken into account by the limiting unit 3. The details relating to the adjusting unit 7 are in particular shown in FIG. 4A and FIG. 4B and are described below.

The limiting unit 3 can thus receive a maximum value 100 from the detection unit 4 and/or the adjusting unit 7, which maximum value corresponds to a maximum current that is to flow through the power cable 10 and/or the secondary connector 15. The limiting unit 3 can either itself perform this specification by actively influencing the flowing current or alternatively transfer the obtained maximum value 100 to a charging controller of the power cable 10 and/or of the vehicle 12 and/or of the power supply device 16. Such a transfer of the maximum value 100 allows the charging controller to take the specification of the maximum current into account during the charging process and to in particular adjust a charging current to at most said maximum value 100. If, on the other hand, the limiting unit 3 is designed to itself influence the flowing current, the limiting unit 3 limits the current autonomously and independently of the charging process, which is, for example, controlled or regulated by a separate control unit of the power cable 10.

A transfer of the maximum value 100 to the charging controller can, merely for example, take place via a communication line, which is provided in the power cable 10 and designed for the communication of the vehicle 12 with a control unit of the power cable 10 and/or a charging controller of the power supply device 16. Alternatively, a transfer can also take place wirelessly. Alternatively, it is advantageously provided that the power cable 10 and/or the secondary connector 15 have a coding indicating a current-carrying capacity of the power cable 10 and/or the secondary connector 15. This coding can, for example, be an electrical resistance. If the vehicle 12 and/or the power supply device 16 recognizes said coding, the vehicle 12 and/or the power supply device 16, on the one hand, will know that a power cable 10 is connected. On the other hand, the current-carrying capacity with which the power cable 10 can at most be loaded is known. By adjusting this coding by means of the limiting unit 3, the current flowing through the power cable 10 and/or the secondary connector 15 can thus be limited. Thus, a simple and reliable transfer of the maximum value to the vehicle 11 and/or the power supply device 16 and/or a control unit of the power cable 10 takes place.

As already described above, the detection unit 4 permits ascertaining an interruption of the current supplied by the power supply device 16. FIG. 3A shows this schematically on the basis of a diagram representing the profile of the current I over the time t. FIG. 3A also shows that the power cable 10 is in a learning mode. In learning mode, it is provided that the limiting unit 3 gradually increases the current flowing through the power cable 10, according to a predefined rule up to the adjusted maximum value 100. The predefined rule comprises a predefined ramp 500 for gradually increasing the flowing current. Thus, in the diagram shown in FIG. 3A, a charging process of the vehicle 11 starts at a starting time t1, for example. However, the current requested by the vehicle 11 is released not directly up to the maximum value 100 but with a predefined gradient, e.g., 1 A/s, according to the predefined ramp 500. In contrast thereto, FIG. 3B shows a corresponding diagram for when the power cable 10 is in a normal mode in which such a gradual increase does not take place. Rather, at the starting time t1, the flowing current is in this case released directly up to the maximum value 100.

If an interruption 400 of the current supplied by the power supply device 16, in particular an interruption that is unexpected or unplanned by the charging control logic and/or the vehicle, takes place, tripping of a fuse of the power supply device 16 or another undesired state or fault is to be assumed. Particularly advantageously, the secondary connector 15 can additionally have a (not shown) acceleration sensor and/or rotation rate sensor and/or a force sensor (which, for example, recognizes that the secondary connector and the mating plug connector of the power supply device 16 are plugged together) and/or another sensor, on the basis of which it can be ascertained that moving the secondary connector 15 and thus separating the secondary connector 15 from the power supply device 16 has not taken place and that there is thus no interruption of the current that is to be expected. The interruption 400 is, merely by way of example, recognized by the detection unit 4 if the supplied electrical current is reduced by, for example, more than 90% in a time interval of less than 1 s, in particular in a time interval of less than 100 ms. Such a short-term and abrupt drop in the electrical current indicates said tripping of the fuse of the power supply device 16 or another fault. If, on the other hand, a drop in the current takes place due to a reached charging end time t2, this drop is, as shown in FIG. 3A and FIG. 3B, not correspondingly abrupt as in the case of the interruption 400. Even if a rather abrupt interruption were to occur here, the interruption is planned, for example by the charging control logic of the vehicle 12 and/or the charging controller of the power cable 10 and/or of the energy supply device 16. This interruption can thus be distinguished from an unplanned interruption by a comparison of the target current profile with an ascertained or sensed actual current profile, e.g., by difference formation.

A limit value 200, which is based on the current value flowing prior to the interruption 400, can be ascertained by the detection unit 4. Thus, the detection unit 4 can, for example, be designed to ascertain the limit value 200 on the basis of the last current value detected prior to the interruption 400. Alternatively or additionally, the limit value 200 can be ascertained by the detection unit 4 on the basis of a plurality of current values prior to the interruption 400, e.g., on the basis of a mean value of a plurality of detected current values in a predefined time window prior to the interruption 400. Such a mean value can, for example, be weighted in such a way that current values that are closer in time to the interruption 400 are given a greater weighting than current values that have a greater time distance from the interruption 400. A further alternative of ascertaining the limit value 200 by means of the detection apparatus 4 is the application of a filtering to a plurality of detected current values prior to the interruption 400. The interruption 400 can, for example, also be ascertained or determined by ascertaining a time derivative of the current profile or a time differential quotient. If the derivative (or its absolute value) exceeds a limit value, this can be evaluated as an indication of the interruption. Advantageously, a safety margin 300 is additionally taken into account, which in particular is at least 5% of the ascertained limit value 200, preferably at least 10%, or is at least 0.5 A or 1.0 A. A limit value 200 that is below the current level that has, for example, led to the tripping of the fuse of the power supply device 16 or to the other fault is ascertained in this way. This limit value 200 can either be transferred or sent directly to the limiting unit 3 by the detection unit 4 so that the limiting unit 3 uses this limit value 200 as the new maximum value 100. Alternatively, the limit value 200 can be output or sent as a proposal for a maximum value 100 to be entered, for example output to a user or on a display. The user of the power cable 10 is thus given assistance in order to specify the maximum value 100. The user in particular does not have to estimate the maximum value 100, which possibly leads to excessively low estimated values. In this case, a current lower than technically possible would be allowed, as a result of which a charging process of the vehicle 11 would be prolonged unnecessarily.

On the basis of FIG. 3A, the detection of the interruption 400 during the learning mode was described. In learning mode, it May be provided, merely for example, that a higher sampling of the flowing current takes place than during the normal mode. The current can in this case, for example, be sampled by a current sensor not shown here. The latter can, for example, be arranged in the secondary connector. It can, for example, be a Hall sensor, etc. If, for example, in normal mode, a current value is ascertained or sensed every 50 ms, it is provided in learning mode that, for example, a current value is ascertained every 10 ms or every millisecond. As a result of the finer sampling and as a result of the predefined ramp 500, it is thus possible to ascertain more accurately than in normal mode at which current level the interruption 400 actually took place. Nevertheless, the detection unit 4 is also designed in normal mode to detect interruptions 400. In any case, the user is thus given assistance by the ascertained limit value 200, with this being possible more accurately in learning mode than in normal mode. In normal mode, there is instead no delay of the current increase by means of the ramp 500, which leads to faster charging of the vehicle 11. The learning mode can advantageously be used if charging is to take place for the first time at an unknown power supply device 16. The learning mode can also be used several times in succession with updated maximum value 100 in order to achieve an approach to the tripping characteristic of the fuse of the power supply device 16.

As shown schematically in FIG. 2, the secondary connector 15, can, for example, particularly advantageously comprise a location sensor 18 (for example, for absolute coordinates, a GPS sensor or a WLAN signal module, for example for identifying MAC addresses or the like, or a sensor for sensing mobile radio data cells or, for relative or charging point-specific data, for example an RFID sensor or the like).

In other words, the location sensor 18 can, for example, be designed as a GPS sensor. However, it can also be a sensor or a device that, for example, performs an (absolute) location determination on the basis of WLAN signals or MAC addresses or a radio cell assignment in mobile radio networks. Other sensors, which enable a (relative) assignment to a location, are also possible. This can, for example, be an RFID reader that can read an RFID chip at a socket and can thereby at least indirectly ascertain a location since sockets are generally not mobile.

As shown here merely by way of example, this location sensor 18 can be provided in the detection unit 4. However, it may also be formed separately therefrom. The location sensor 18 serves to ascertain a current location of the power cable 10 and/or of the secondary connector 15. A link between the (ascertained or adjusted) limit value 200 and a location at which the limit value 200 was ascertained or adjusted can be established and/or stored by the location sensor 18, for example in a memory 19 of the secondary connector 15. The location at which the limit value 200 was ascertained or adjusted thus corresponds to the location of the power supply device 16. The power supply device 16 can thus be characterized via the location so that the stored location can be recognized when this power supply device 16 is used again. The secondary connector 15 can, for example, be designed (e.g., in that, in addition to the location sensor, the memory 19 is also provided in the secondary connector 15), when a location at which a limit value 200 is stored linked is reached, to transfer the limit value 200 linked to the location, as the maximum value 100 to the limiting unit 3. Alternatively or additionally, the secondary connector 15 can, for example, be designed to output the linked limit value 200 as a proposal for adjusting as the maximum value 100. For example, the detection unit 4 can be configured or designed in such a way that the link just shown is carried out or performed in it. The location sensor 18 and the memory 19 can then, for example, be arranged or provided in the detection unit 4, wherein the location sensor 18 and the memory 19 can also be provided at different locations or on or in different components in the secondary connector 15. The user of the power cable 10 can thus access already performed ascertainments of the limit value 200. The risk of tripping the fuse of the power supply device 16 during repeated use of the power supply device 16 is thus advantageously minimized.

FIGS. 4A and 4B show two possible exemplary embodiments for the secondary connector 15.

In FIG. 4A, the adjusting unit 7 is designed as a rotary control. By means of this rotary control, a continuous adjustment of the maximum value 100 can, for example. be brought about, i.e., a stepless adjustment. Alternatively, it is also possible for different latching stages to be provided so that only a fixedly defined plurality of maximum values 100 can be adjusted, for example separated from one another by latching steps. For example, 1 A, 2 A, 4 A, 6 A, 8 A, 10 A and 13 A can be fixedly predefined as maximum value stages.

In FIG. 4B, the adjusting unit 7 is designed, by way of example, as a sliding control. Here, too, as in FIG. 4A, a continuous adjustment of the maximum value 100 is just as possible as a stepped adjustment to fixedly defined maximum values 100.

Preferably, as shown in FIGS. 4A and 4B, the secondary connector 15 also has a release unit 20, which is designed for releasing the adjustability of the maximum value 100 via the adjusting unit 7. The release unit 20 can, for example, be a locking slider and/or a mechanical or electronic lock and/or a fingerprint sensor. It is thus prevented that an adjustment of the maximum value takes place unintentionally. Prior to adjusting the maximum value 100, the release is thus to be performed via the release unit 20, wherein, in the case of the use of a locking slider, this is in particular merely a protection against unintentionally adjusting, e.g., by unintentionally touching, the adjustment apparatus. If, on the other hand, a mechanical and/or electronic lock and/or a fingerprint sensor is used, a protection against unauthorized manipulation is also enabled. The release by the release unit 20 can in particular be indicated visually and/or acoustically. It is also advantageously possible for the limiting unit 3 to allow no current flow through the secondary connector 15 and/or the power cable 10 during the release for adjusting the maximum value 100.

The release by the release unit 20 can take place mechanically so that without release the adjusting unit 7 is mechanically locked. Alternatively or additionally, the release can also take place electronically so that, for example, new maximum values 100 will only be accepted when this is released by the release unit 20, even though the adjusting unit 7 can still be operated.

FIG. 5 schematically shows a further embodiment of the secondary connector 15. The latter has a touchscreen as the adjusting unit 7, and a keypad can likewise also be used as the adjusting unit 7.

A memory 19 (cf. FIG. 2), which serves to store different maximum values 100, is advantageously provided. This is in particular advantageous if the adjusting unit 7 does not have a slider and/or a rotary knob as described above. By storing different maximum values, the user can select his own favorite values simply and cost-effectively, for example if the power cable 10 is repeatedly used at the same power supply devices 16 with different power supply capacities or fusing. The values stored in the memory 19 can in particular be selected and adjusted as the maximum value 100 via the touchscreen or the keypad as the adjusting unit 7.

As shown in FIG. 5, the secondary connector 15 advantageously has an output unit 17, which can also be present in the embodiments shown in FIG. 4A and FIG. 4B. The output unit 17 serves to output a signal if the detection unit 4, which is merely optionally provided, has detected said interruption 400. In addition, the output unit 17 advantageously serves to output a signal that the maximum value 100 adjusted by the limiting unit 3 is lower than a maximally possible current-carrying capacity of the secondary connector 15 and/or of the power cable 10. The signal can, for example, be output directly acoustically and/or visually. Alternatively, a user terminal via which said signals can be output to the user can also be coupled to the secondary connector 15.

Particularly advantageously, a communication module 8 for wireless and/or wired communication with a user terminal is provided. In particular, the maximum current 100 can be adjusted via the user terminal. The communication module 8 can advantageously also serve, as described above, to output signals via the user terminal.

The secondary connector 15 is advantageously designed, for example via the output unit 17 and/or the communication module 8 and/or via a display (see FIG. 5), which may be part of a touchscreen or may be formed separately, to indicate the factor or the time span by which the charging time is prolonged through the limitation of the current flow. In particular, the secondary connector 15 is designed to indicate how long the charging of a certain amount of energy, e.g., 10 kWh, is expected to take in the case of the selected limitation (see FIG. 5: here, 5 hours and 14 minutes are indicated by way of example). In this way, a user can adjust the maximum current in a targeted manner to the available charging time (e.g., from 8 pm to 6 am).

The figures do not show an optionally possible reset switch or a reset device. With the latter, for example by a single operating process, the maximum value 100 can be adjusted directly to a (technically) maximally possible maximum value 100 without having to perform further adjustment processes. This (technically) maximally possible maximum value can, for example, be 13 A in the case of a Schuko secondary connector 15.

It is understood that the secondary connector 15 is preferably designed as an element that can be detached or decoupled from the connecting line 13, in the manner of an adapter. It can nevertheless be provided that the secondary connector is connected fixedly, i.e., not in a non-destructively detachable manner, to the connecting line 13 and/or to the power cable 10.

1-13. (canceled)

14. A secondary connector of a power cable, which is configured for electrical connection to a vehicle, the secondary connector comprising
a plug-in connector for detachable electrical connection to a power supply device;
a cable connection for detachable electrical connection to a coupling of the power cable;
a limiting unit configured to limit an electrical current flowing through the power cable to a maximum value; and
an adjusting unit via which the maximum value can be adjusted.

15. The secondary connector according to claim 14, wherein, for adjusting the maximum value, the adjusting unit has a rotary knob or a slider or a touchscreen or a keypad.

16. The secondary connector according to claim 14, wherein: (i) the maximum value can be selected from a plurality of predefined values via the adjusting unit, or (ii) the maximum value can be adjusted steplessly from a predefined interval via the adjusting unit.

17. The secondary connector according to claim 14, wherein the secondary connector has a memory which is configured for storing different maximum values by a user.

18. The secondary connector according to claim 14, wherein the secondary connector has a communication module for communication with a user terminal in order to adjust the maximum value via the user terminal, and wherein the communication module is configured for wireless communication with the user terminal.

19. The secondary connector according to claim 14, wherein the secondary connector has a release unit, which is configured for releasing the adjustability of the maximum value via the adjusting unit, wherein the release unit includes a locking slider and/or a mechanical or electronic lock and/or a fingerprint sensor.

20. The secondary connector according to claim 14, wherein the secondary connector has a reset function, wherein, when the reset function is activated, a technically maximally possible maximum value is adjusted, and wherein the reset function can be activated by a user and/or is activated when a supply cable is decoupled from the power supply device.

21. The secondary connector according to claim 14, wherein the limiting unit is configured to output the maximum value to the vehicle and/or to a charging control logic of the power cable or of the power supply device in order to notify the vehicle that at most the maximum value can be requested as a charging current.

22. The secondary connector according to claim 14, wherein the secondary connector includes a detection unit, wherein the detection unit is configured to monitor electrical current supplied by the power supply device and to detect an interruption of supplied electrical current.

23. The secondary connector according to claim 22, wherein the secondary connector has an output unit, wherein the output unit is configured to output a signal including an acoustic and/or visual warning, when the detection apparatus detects the interruption, and/or to output a signal that the maximum value adjusted by the limiting unit is lower than a technically maximally possible maximum value.

24. The secondary connector according to claim 22, wherein the detection unit is configured to transfer a limit value based on a current supplied prior to the detection of the interruption with a predefined safety margin, as the maximum value to the limiting unit and/or to output the limit value as a proposal for adjusting as the maximum value.

25. A power cable for electrical connection of an energy store of a vehicle to a power supply device providing electrical energy, the power cable comprising:
a connecting line;
a primary connector which is or can be electrically coupled to the connecting line and has a vehicle connection for detachable electrical connection to the energy store of the vehicle; and
a secondary connector which is or can be electrically coupled to the connecting line and is provided for detachable electrical connection to the power supply device;
wherein the secondary connector has a limiting unit, which is configured to limit an electrical current flowing through the power cable to a maximum value; and
wherein the secondary connector has an adjusting unit via which the maximum value can be adjusted.

26. The power cable according to claim 25, wherein the connecting line has a coupling which is configured to be detachably electrically connected to the secondary connector.
